(19) United States
(12) Patent Application Publication
(10) Pub. No.: US 2023/0249012 A1
(43) Pub. Date: Aug. 10, 2023

(54) STRAPLESS FACE MASK

(71) Applicant: SPIDERTECH INC., Toronto (CA)

(72) Inventor: Roman ARBESMAN, Toronto, Ontario (CA)

(21) Appl. No.: 18/002,954

(22) PCT Filed: Jun. 25, 2021
(86) PCT No.: PCT/CA2021/050880

§ 371 Date: Dec. 22, 2022

Related U.S. Application Data
(60) Provisional application No. 63/050,475, filed on Jul. 10, 2020.
(60) Provisional application No. 63/044,775, filed on Jun. 26, 2020.

(51) Int. Cl. A62B 18/08; A41D 13/11; A62B 23/02

(52) U.S. Cl. CPC A62B 18/084; A41D 13/1176; A62B 23/025; A41D 2500/20

(57) ABSTRACT

A facial mask comprising a flexible body of woven material comprising an inner surface and an opposed outer surface; an adhesive on the inner surface; and a backing material releasably attached to the inner surface, the backing material having a first portion and at least one second portion, wherein the at least one second portion is removable to expose the adhesive for engagement on a user's face.

### FIELD

Aspects of this disclosure relate to face masks. More specifically, this disclosure relates to face masks that reduce the transmission of pathogens.

### BACKGROUND

Numerous infectious human diseases, such as human respiratory tract infections, are caused by human pathogens such as bacteria, fungi and viruses. For example, viral causes of infectious human diseases (and their associated diseases) include: Influenza A virus (including ‘swine flu’ such as the 2009 H1N1 strain); Influenza B-C virus (coryza; ‘common cold’); Human adenovirus A-C (various respiratory tract infections; pneumonia); severe acute respiratory syndrome (SARS); coronavirus 2 (SARS-CoV-2); and Middle East respiratory syndrome coronavirus (MERS-CoV). Some of the human respiratory tract infections result in significant morbidity and mortality.

Among the modes of transmission of these infectious human diseases are by airborne transmission of infectious particles expelled from the respiratory tract of an infected person by coughing or sneezing, or by simple exhalation, and into the gastrointestinal or respiratory systems of a previously non-infected person by inhalation. To combat this form of transmission, facial masks have been developed that intercept the infectious particles. Generally, protective facial masks are designed to be worn by both the infected person to prevent transmission of infection, and by the non-infected person to prevent being infected. Facial masks generally are produced in only a few sizes or only one size, and therefore such conventional facial masks tend not to fit a substantial portion of the human population sufficiently tight around the face, and in particular around the nose of the user to prevent near complete ingress or egress of the airborne infectious particles. To address this deficiency, facial masks have been designed to incorporate mechanical structures, such as nose clips and elastic bands that loop around the ears to seal the facial mask against the face of the user by increasing the force that holds the facial mask in place, thereby deforming the perimeter of the facial mask to more tightly fit the face of the user. While mitigating the problem, these mechanical structures create an unpleasant sensation of pressure for the user over time, and tend to limit the period that the facial mask can be worn.

### SUMMARY

In one aspect, there is provided a facial mask comprising:

a flexible body of woven material comprising an inner surface and an opposed

outer surface;

an adhesive on the inner surface; and

a backing material releasably attached to the inner surface, the backing material having a first portion and at least one second portion, wherein the at least one second portion is removable to expose the adhesive for engagement on a user's face.

In another aspect, there is provided a strapless facial mask comprising:
a flexible body of woven material comprising an inner surface and an opposed outer surface;

an adhesive on the inner surface; and

a backing material releasably attached to the inner surface, the backing material comprising a first backing material portion, a central backing material portion and a second backing material portion, and

wherein the first backing material portion and the second backing material portion is removable to expose the adhesive for engagement on a user's face, while the central backing material portion remains on the inner surface when the mask is engaged on the user's face.

In yet another aspect, there is provided a strapless face mask comprising: a body adaptable to fit contours of a human face, the body comprising an inner surface and an outer surface, the inner surface having an adhesive for adhering to the human face, wherein a portion of the body covers the user's mouth and nose.

In yet another aspect, there is provided a face mask comprising:

a body adaptable to fit contours of a human face, the body comprising an inner surface and an outer surface, the inner surface having an adhesive for adhering to the human face, wherein a portion of the body covers the user's mouth and nose; and

wherein the face mask is supported on the user's face by the adhesive only.

In yet another aspect, there is provided a face mask having a body adaptable to fit contours of a human face e.g. nose and cheeks, and capable of substantially minimizing the escape of pathogens between the periphery of the face mask and the contours of the user's face, while allowing for a substantially improved fit and comfort.

In another aspect, there is provided a roll comprising:

a web material with a plurality of face masks, wherein each of the plurality of face masks comprises a flexible body of woven material comprising an inner surface and an opposed outer surface; an adhesive on the inner surface; and a backing material releasably attached to the inner surface, the backing material having a first portion and at least one second portion, wherein the at least one second portion is removable to expose the adhesive for engagement on a user's face; and

wherein the web material comprises a perforation or cut between each of the plurality of face masks.

Advantageously, the face mask is secured on a user's face by an adhesive only, and without the use of nose clips, straps or elastic bands retained by the head or ears of the user present in conventional face masks.

### BRIEF DESCRIPTION OF THE DRAWINGS

The detailed description refers to the drawings briefly described below:

FIG. 1a shows a rear view of a face mask, in an exemplary embodiment;

FIG. 1b shows a front view of the face mask of FIG. 1a;

FIG. 2a shows a side view of a roll of web material with individual face masks of FIG. 1a;

FIG. 2b shows a top view of the roll of web material with individual face masks of FIG. 1a;

FIG. 3 shows a rear view of a face mask, in another exemplary embodiment; and

FIG. 4 shows a top view of a roll of web material with individual face masks of FIG. 3.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Spatially relative terms, such as “inner,” “outer,” “beneath”, “below”, “lower”, “above”, “upper”, “rear”, “front” and the like, may be used herein for ease of description to describe one element or feature's relationship to another element(s) or feature(s) as illustrated in the figures. Spatially relative terms may be intended to encompass different orientations of the mask in use or operation in addition to the orientation depicted in the figures. For example, if the mask in the figures is turned over, elements described as “below” or “beneath” other elements or features would then be oriented “above” the other elements or features. Thus, the example term “below” can encompass both an orientation of above and below. The mask may be otherwise oriented (rotated 90 degrees or at other orientations) and the spatially relative descriptors used herein interpreted accordingly.

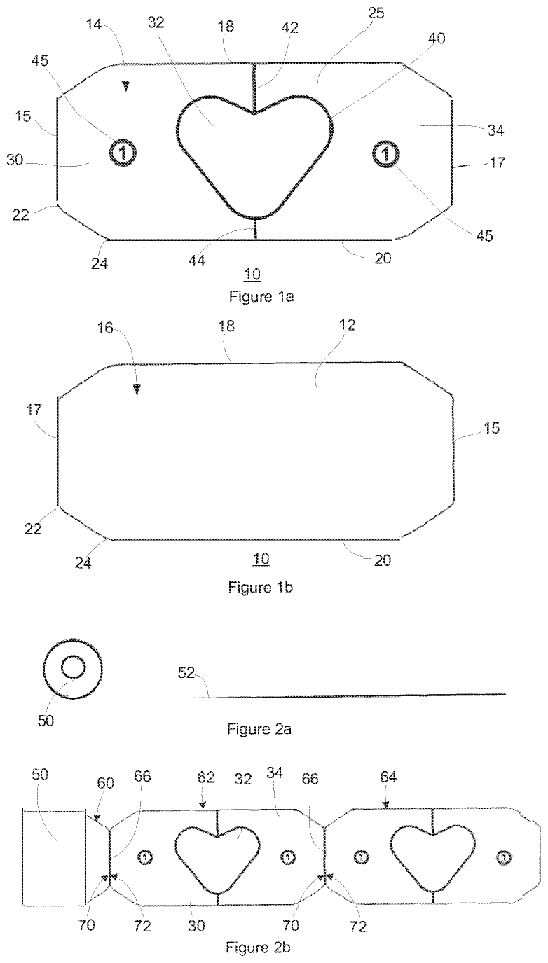

As shown in FIGS. 1a and 1b, face mask 10 is generally sized to fit over the nose and mouth of a user, and comprises elongated flexible body 12 of porous material of elastic and non-elastic fibers. The individual fibers are woven together to produce a cloth-like product that is able to stretch in a single direction. Elongated flexible body 12 can include an approximately rectangular shape, and comprises inner surface 14 and outer surface 16. When donned on a user's face inner surface 14 is proximal to the face of the user, and outer surface 16 is distal to the face of the user. In particular, the face mask 10 extends in a longitudinal direction from left end 15 to right end 17, and in a transverse direction from top end 18 to bottom end 20. The width and length of face mask 10 can be changed as desired to fit various individuals, such as children and adults. As an example, the width of elongated flexible body 12 may be about 4 inches. Similarly, typical lengths of each individual elongated flexible body 12 may be about 9 inches. As can be seen in FIGS. 1a and 1b, the corners of face mask 10 can include curved corners 22, 24. In at least one implementation, curved corners 22, 24 can prevent fraying during application. Additionally or alternatively, curved corners 22, 24 can reduce the chance of accidental detachment during use of the face mask 10. For example, curved corners 22, 24 are much less likely than a square corner to snag on other materials, such as the user's clothing, that might detach the face mask 10 during use. Additionally or alternatively, curved corners 22, 24 can provide more comfort to the user, as curved corners 22, 24 do not have sharp corners that can poke the user or otherwise cause discomfort.

Face mask 10 can include backing material 25 disposed underneath elongated flexible body 12. In at least one implementation, backing material 25 is releasably attached to elongated flexible body 12 by an adhesive layer. In particular, backing material 25 can include paper or any other material suitable for protecting the adhesive on elongated flexible body 12 from drying or sticking on unintended surfaces before use. For example, backing material 25 can include a waxed paper which protects the adhesive from being removed or drying.

In at least one implementation, backing material 25 may comprise a plurality of portions, such as first backing material portion 30, central backing material portion 32 and second backing material portion 34, as shown in FIG. 1a. In one example, central backing material portion 32 is centrally disposed on elongated flexible body 12 such that central backing material portion 32 is bordered by first backing material portion 30 and second backing material portion 34. Central backing material portion 32 comprises perimeter perforation 40, and top transverse perforation 42 between first backing material portion 30 and second backing material portion 34, and top transverse perforation 42 extends from top end 18 to perimeter perforation 40, and bottom transverse perforation 44 between first backing material portion 30 and second backing material portion 34 and bottom transverse perforation 44 extends from bottom end 20 to perimeter perforation 40. Generally top transverse perforation 42 and bottom transverse perforation 44 are located about halfway between left end 15 and right end 17 of face mask 10. In particular, perforations 40, 42, 44 can allow portions of backing material 25 to be removed from elongated flexible body 12 while other portions of backing material 25 remain on elongated flexible body 12. For example, perforations 40, 42, 44 can allow first backing material portion 30 to be removed from elongated flexible body 12 and a first uncovered portion of elongated flexible body 12 is applied to the user's face to provide a first anchor on the user's face via the adhesive. Subsequently, second backing material portion 34 is removed from elongated flexible body 12, and a second uncovered portion of elongated flexible body 12 is applied to the user's face to provide a second anchor on the user's face via the adhesive, while central backing material portion 32 remains adhered to elongated flexible body 12. Accordingly, this can facilitate placement of face mask 10 by allowing the user to only work with desired sections of face mask 10. The adhesive on the exposed portion of elongated flexible body 12 engages a sufficient contact area with the face of the user to maintain face mask 10 on the user's face while allowing the user to breathe through the porous material of elastic and non-elastic fibers of flexible body 12, with central backing material portion 32 substantially intercepting infectious particles. The engagement also inhibits the passage of particles between the periphery of face mask 10 and the user's face while providing enhanced comfort to the user.

In at least one implementation, backing material 25 can be placed on elongated flexible body 12 before perforations 40, 42, 44 are formed in backing material 25. For example, perforations 40, 42, 44 may be formed by die cutting through backing material 25.

FIGS. 2a and 2b illustrate roll 50 of web material 52 containing face masks 10. For example, roll 50 can include individual strips of elongated flexible body 12 and associated individual strips of backing material 25 forming individual face masks 60, 62, and 64. In at least one implementation, elongated flexible body 12 and backing material 25 of face mask 10 can be cut by a user to remove a single face mask 60, 62, or 64 from roll 50. Additionally or alternatively, elongated flexible body 12 and backing material 25 can include a cut across its width between each individual face mask 10, to facilitate dispensing of face mask 10 from roll 50. Accordingly, roll 50 comprises a continuous strip of detachable consecutive interconnected face mask products 10. For example, transverse perforation or cut 66 is made, with suitable dies, between consecutive face mask 62 and 64 at the interface of right end 70 of face mask 62 and left end 72 of face mask 64. Transverse perforation or cut 66 is also made between consecutive face masks 60 and 62 at the interface of right end 70 of face mask 60 and left end 72 of face mask 62.

In at least one implementation as shown in FIG. 3, face mask 80, similar to face mask 10 as described with reference to FIGS. 1a and 1b, comprises elongated flexible body 12 with an approximately rectangular shape, and comprises inner surface 14 and outer surface 16. Inner surface 14 comprises backing material 25 which may comprise a plurality of portions, such as first backing material portion 30, central backing material portion 32, second backing material portion 34, and top backing material portion 35.

In one example, central backing material portion 32 is centrally disposed on elongated flexible body 12 such that central backing material portion 32 is bordered by first backing material portion 30, and second backing material portion 34, and top backing material portion 35. Central backing material portion 32 comprises perimeter perforation 40, and first top transverse perforation 46 between first backing material portion 30 and top backing material portion 35 extends from top end 18 to perimeter perforation 40; second top transverse perforation 47 between second backing material portion 34 and top backing material portion 35 extends from top end 18 to perimeter perforation 40, while bottom transverse perforation 44 between first backing material portion 30 and second backing material portion 34 extends from bottom end 20 to perimeter perforation 40. Generally bottom transverse perforation 44 is located about halfway between left end 15 and right end 17 of face mask 80. In particular, perforations 40, 44, 46, and 47 allow portions of backing material 25 to be removed from elongated flexible body 12 while other portions of backing material 25 remain on elongated flexible body 12.

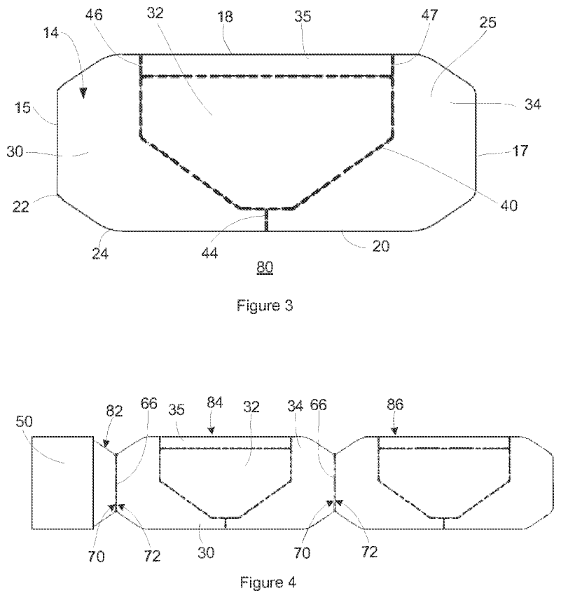

FIG. 4 illustrates roll 50 of web material 52 containing face masks 80. For example, roll 50 can include individual strips of elongated flexible body 12 and associated individual strips of backing material 25 forming individual detachable face masks 82, 84, 86, as described above with reference to FIGS. 2a and 2b.

In at least one implementation, face mask 10 may be formed from a variety of materials and fabrics, such as woven reusable fabrics and nonwoven disposable fabrics or webs. As used herein, the term “nonwoven fabric” or “nonwoven web” or “nonwoven material” means a web having a structure of individual fibers or threads that are randomly interlaid, but not in an identifiable manner or pattern as in a knitted fabric. Nonwoven fabrics or webs have been formed using various processes.

In at least one implementation, the woven material may be or may include, for example, woven cotton (similar to or the same as woven cotton used in kinesiology tapes).

In at least one implementation, flexible body 12 may be formed in any number of shapes and dimension, and backing material 25 may comprise a plurality of portions of any number of shapes and dimensions.

In at least one implementation, central backing material portion 32 redirects airflow, droplets and particles emitted by the user downward towards the user's chin, that is, toward bottom end 20. As such, the central backing material portion 32 minimizes droplet dispersal, shortens the trajectory of droplets and particles of droplets emitted by the user, especially when coughing or sneezing, and reduces the travel distance of the droplets and particles away from the user. Advantageously, fogging of spectacles or goggles worn by the user is substantially minimized. In addition, central backing material portion 32 allows for a large pocket of air between central backing material portion 32 and the user's face.

In at least one implementation, backing material 25 includes markings or indicia 45 to assist the user in the application of face mask 10, 80. For example, markings 45 as shown are numerical markings, indicating which portions of backing material portion 25 may be removed, in order to facilitate stepwise application of face mask 10, 80. In other examples, the markings may be alphabetical markings, or pictorial markings. In other examples, markings may be provided elsewhere, such as on a separate instruction sheet.

The descriptions of the various embodiments of the disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A facial mask comprising:
a flexible body of woven material comprising an inner surface and an opposed outer surface;
an adhesive on the inner surface; and
a backing material releasably attached to the inner surface, the backing material having a first portion and at least one second portion, wherein the at least one second portion is removable to expose the adhesive for engagement on a user's face.

2. The facial mask of claim 1, wherein the first portion is centrally located on the inner surface and remains on the inner surface when the mask is engaged on the user's face.

3. The facial mask of claim 1, wherein the backing material comprises perforations or cuts along a boundary between the first portion and the at least one second portion.

4. The facial mask of claim 1, wherein the flexible body is adaptable to fit contours of the user's face.

5. The facial mask of claim 1, wherein the first portion is dimensioned to substantially cover a mouth and nose of the user, and the adhesive exposed following removal of the at least one second portion interfaces with an area surrounding the mouth and the nose to maintain the facial mask in place on the user's face.

6. The facial mask of claim 1, wherein the first portion minimizes passage of particles therethrough from the inner surface to the outer surface or from the outer surface to the inner surface.

7. The facial mask of claim 5, wherein the first portion redirects the user's breath, droplets and particles downward away from the user's eyes, thereby minimizing the dispersal of the droplets and particles and shortening the trajectory of droplets and particles of droplets emitted by the user.

8. The facial mask of claim 5, wherein the first portion allows for a large pocket of air between the facial mask and the user's face.

9. The facial mask of any one of claims 1 to 8, wherein the flexible body is composed of a porous material.

10. The facial mask of claim 9, wherein the flexible body is composed of elastic fibers.

11. The facial mask of claim 9, wherein the flexible body is composed of non- elastic fibers.

12. The facial mask of claim 9, wherein the flexible body is composed of elastic fibers and non-elastic fibers.

13. The facial mask of any one of claims 1 to 12, wherein the flexible body is composed of fibers, wherein the fibers are woven together such that the flexible body that is able to stretch in a single direction only.

14. The facial mask of claim 13, wherein the flexible body comprises a substantially rectangular shape.

15. The facial mask of claim 14, wherein the flexible body comprises curved corners.

16. The facial mask of any one of claims 1 to 15, wherein the at least one second portion comprises one or more portions.

17. The facial mask of any one of claims 1 to 16, wherein the facial mask is reusable.

18. The facial mask of any one of claims 1 to 17, wherein the facial mask is self-supported on the user's face by the adhesive only.

19. A strapless facial mask comprising:
a flexible body of woven material comprising an inner surface and an opposed outer surface;
an adhesive on the inner surface; and
a backing material releasably attached to the inner surface, the backing material comprising a first backing material portion, a central backing material portion and a second backing material portion, and
wherein the first backing material portion and the second backing material portion is removable to expose the adhesive for engagement on a user's face, while the central backing material portion remains on the inner surface when the mask is engaged on the user's face.

20. The strapless facial mask of claim 19, wherein the central backing material portion is centrally disposed on the flexible body such that the central backing material portion is bordered by the first backing material portion and the second backing material portion.

21. The strapless facial mask of claim 20, wherein the central backing material portion comprises a perimeter perforation, a top transverse perforation between the first backing material portion and the second backing material portion, wherein the top transverse perforation extends from a top end of the flexible body to the perimeter perforation, and a bottom transverse perforation between the first backing material portion and the second backing material portion, wherein the bottom transverse perforation extends from a bottom end of the flexible body to the perimeter perforation.

22. The strapless facial mask of claim 19, wherein the adhesive exposed upon removal of the first backing material portion and the second backing material portion adjacent the top end of the flexible body engages the user's face below the user's eyes to provide a seal to minimize egress of any droplets, particles and expelled air from the user via the top end.

23. The strapless facial mask of claim 22, wherein the central backing material portion directs the movement of the droplets, the particles and the expelled air towards the bottom end.

24. The strapless facial mask of claim 21, wherein the perforations allow the first backing material portion to be removed from flexible body to:
(a) expose a first uncovered portion of the flexible body, and apply the first uncovered portion of the flexible body to the user's face to provide a first anchor on the user's face via the adhesive;
(b) expose a second uncovered portion of the flexible body, and apply the second uncovered portion of the flexible body to the user's face to provide a second anchor on the user's face via the adhesive; and
(c) maintain the central backing material portion on the flexible body.

25. The strapless facial mask of claim 19, wherein the adhesive on the exposed portion of the flexible body engages a sufficient contact area with the user's face to maintain the mask on the user's face while allowing the user to breathe through the flexible body, with central backing material portion substantially intercepting infectious particles, and inhibiting the passage of particles between a periphery of the mask and the user's face while providing enhanced comfort to the user.

26. The strapless facial mask of any one of claims 19 to 25, wherein the mask is reusable.

27. The strapless facial mask of any one of claims 19 to 26, wherein the mask comprises indicia to assist the user in the application of the mask.

28. The strapless facial mask of claim 27, wherein the indicia indicates which portions of backing material may be removed and applied for stepwise, sequential application of the face mask.

29. The strapless facial mask of claim 28, wherein the indicia comprises numerical markings, alphabetical markings, pictorial markings, and/or instructions.

30. The strapless facial mask of any one of claims 19 to 29, wherein the flexible body is supported on the user's face by the adhesive only.

31. A strapless face mask comprising:
a body adaptable to fit contours of a human face, the body comprising an inner surface and an outer surface, the inner surface having an adhesive for adhering to the human face, wherein a portion of the body covers the user's mouth and nose.

32. The strapless face mask of claim 31, wherein the portion of the body covering the user's mouth and nose comprises an adhesive backing releasably attached to the inner surface, such that the adhesive backing faces the user's mouth and nose.

33. The strapless face mask of claim 31, wherein the adhesive backing minimizes the ingress or egress of droplets and particles.

34. The strapless face mask of claim 31, wherein securing the body below the nose and around the mouth provides a seal around the nose and the mouth.

35. The strapless face mask of claim 33, wherein the adhesive backing directs the user's breath, droplets and particles downward away from the user's eyes, thereby minimizing the dispersal of the droplets and particles and shortening the trajectory of droplets and particles emitted by the user.

36. The strapless face mask of any one of claims 31 to 35, wherein the body is self-supported on the user's face by the adhesive only.

37. The strapless face mask of any one of claims 31 to 36, wherein the body is composed of a porous material.

38. The strapless face mask of any one of claims 31 to 36, wherein the body is composed of elastic fibers.

39. The strapless face mask of any one of claims 31 to 36, wherein the body is composed of non-elastic fibers.

40. The strapless face mask of any one of claims 31 to 36, wherein the body is composed of elastic fibers and non-elastic fibers.

41. The strapless face mask of any one of claims 31 to 36, wherein the individual fibers are woven together such that the body that is able to stretch in a single direction only.

42. A face mask comprising:
a flexible body comprising an inner surface and an outer surface, the inner surface having an adhesive for adhering to a user's face, wherein a portion of the flexible body covers the user's mouth and nose; and
wherein the flexible body is supported on the user's face by the adhesive only.

43. The face mask of claim 42, wherein the portion of the flexible body covering the user's mouth and nose comprises an adhesive backing releasably attached to the inner surface, such that the adhesive backing faces the user's mouth and nose.

44. The face mask of claim 43, wherein the adhesive backing minimizes the ingress and the egress of droplets and particles.

45. The face mask of claim 44, wherein the adhesive backing directs the user's breath, droplets and particles downward away from the user's eyes, thereby minimizing the dispersal of the droplets and particles and shortening the trajectory of droplets and particles emitted by the user.

46. The face mask of any one of claims 42 to 45, wherein the body is composed of a porous material.

47. The face mask of any one of claims 42 to 45, wherein the body is composed of elastic fibers.

48. The face mask of any one of claims 42 to 45, wherein the body is composed of non-elastic fibers.

49. The face mask of any one of claims 42 to 45, wherein the body is composed of elastic fibers and non-elastic fibers.

50. The face mask of any one of claims 42 to 45, wherein the individual fibers are woven together such that the body that is able to stretch in a single direction only.

51. A roll comprising:
a web material with a plurality of face masks, wherein each of the plurality of face masks comprises a flexible body of woven material comprising an inner surface and an opposed outer surface; an adhesive on the inner surface; and a backing material releasably attached to the inner surface, the backing material having a first portion and at least one second portion, wherein the at least one second portion is removable to expose the adhesive for engagement on a user's face; and
wherein the web material comprises a perforation or cut between each of the plurality of face masks.

52. The roll of claim 51, wherein the web material comprises a continuous strip of detachable consecutive interconnected face mask.
